(19) United States
(12) Patent Application Publication
(10) Pub. No.: US 2002/0093171 A1
(43) Pub. Date: Jul. 18, 2002

(54) Scooter-like bicycle

(76) Inventor: Jui-Kuang Chen, Miaoli Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/863,304

(22) Filed: May 24, 2001

(30) Foreign Application Priority Data
Jan. 15, 2001 (TW) 90100843

(51) Int. Cl. B62M 1/04

(52) U.S. Cl. 280/253; 280/258

(57) ABSTRACT

A scooter-like bicycle having a simple labor-saving power transmission mechanism is provided. The mechanism comprises a clockwise gear, a crank, and two pedals each having one end coupled to main frame and the other end coupled to a bearing. The bicycle moves as rider pushes pedals in a reciprocating motion. Torque of the bicycle is a total length consisting of the length of crank and the length of most portions of pedal times a force exerted on pedals. Hence, it may lessen physical labor. Further, in use total weight of rider is exerted on pedals since rider is at a standing position. This can save the physical labor of legs. Furthermore, there is no restriction on the wearing of rider.

### FIELD OF THE INVENTION

The present invention relates to scooters and more particularly to an improved scooter-like bicycle which is advantageous for saving labor through a simple power transmission mechanism.

### BACKGROUND OF THE INVENTION

A conventional bicycle is powered by rider sitting on saddle applying force on pedals for transmitting motion through a power train consisting of cranks coupled to pedals, chain wheel, drive chain, sprocket cluster, and rear wheel. In view of above, However, most force is exerted by legs, resulting in much physical labor consumption. This condition is even obvious when people rides a bicycle on an uphill road. Thus, it is desirable to provide an improved scooter-like bicycle which is advantageous for being labor-saving through a simple power transmission mechanism in order to overcome the above drawbacks of prior art.

### SUMMARY OF THE INVENTION

It is an object of the present invention to provide a scooter-like bicycle which is advantageous for saving labor through a simple power transmission mechanism.

It is another object of the present invention to provide a scooter-like bicycle having a simple power transmission mechanism, resulting in a further simplification of the structure.

It is still another object of the present invention to provide a scooter-like bicycle which does not restrict the wearing of people who rides the bicycle.

The above and other objects, features and advantages of the present invention will become apparent from the following detailed description taken with the accompanying drawings.

### BRIEF DESCRIPTION OF THE DRAWINGS

FIGS. 1A and 1B are side views schematically illustrating operations of power transmission mechanism incorporated in a scooter-like bicycle according to the invention, respectively;

FIG. 1C is an enlarged view of a portion of FIG. 1B;

FIG. 2 is side view of a first preferred embodiment of scooter-like bicycle according to the invention;

FIG. 3 is an exploded view of power transmission mechanism of FIG. 2;

FIGS. 4A, 4B and 4C are side views schematically illustrating operations of power transmission mechanism of FIG. 2 bicycle, respectively;

FIG. 5 is side view of a second preferred embodiment of scooter-like bicycle according to the invention;

FIG. 5A is an exploded view of power transmission mechanism of FIG. 5;

FIG. 6 is side view of a third preferred embodiment of scooter-like bicycle according to the invention; and

FIG. 6A is an exploded view of power transmission mechanism of FIG. 6.

### DETAILED DESCRIPTION OF THE PREFERRED EMBODIMENTS

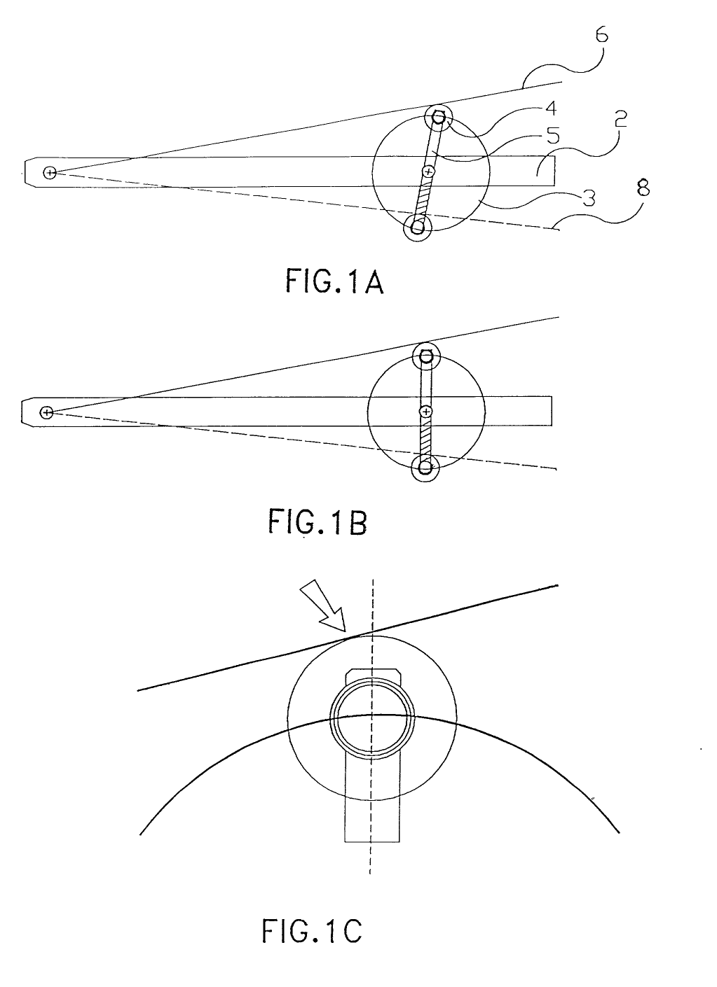

Referring to FIGS. 1A to 1C, operations of power transmission mechanism of a scooter-like bicycle constructed in accordance with the invention are illustrated. The power transmission mechanism comprises a main frame 2, a clockwise gear 3, a bearing 4, a crank 5, a first pedal 6, and a second pedal 8. A bottom portion of first pedal 6 is coupled to bearing 4 which is mounted on crank 5. Further, crank 5 is coupled to axle of clockwise gear 3. Furthermore, one end of first pedal 6 is pivotably coupled to a front end of main frame 2. Axle of clockwise gear 3 is rotatably coupled to a position near the rear end of main frame 2. In FIG. 1A, first pedal 6 is pressed by user to move to a position at an angle about 30 degrees with respect to a virtual vertical line. Hence, bearing 4 coupled to first pedal 6 will cause crank 5 to rotate clockwise to a position coincidental with the vertical line (FIG. 1B). At this position the characteristics of the invention is significant, i.e., clockwise gear 3 only rotates clockwise when force exerted on pedals 6 and 8 is either continuous or intermittent as best illustrated in FIG. 1C. As shown, both bearing 4 and crank 5 are perpendicular to main frame 2. One end of first pedal 6 is pivotably coupled to a front end of main frame 2, while a bottom portion of first pedal 6 is coupled to a periphery of bearing 4 (i.e., forms a tangent located at the left of the vertical line). Such tangent is the point where force is exerted on first pedal 6 while riding. Thus, a rightward rotational force is generated. As a result, both bearing 4 and crank 5 rotate clockwise. To the contrary, if tangent is located at the left of the vertical line, clockwise gear 3 will rotate counterclockwise.

As known that torque of a conventional bicycle is simply the length of crank times a force exerted on pedal since chain wheel is coupled to crank. In comparison, torque of scooter-like bicycle of the invention is a total length consisting of the length of crank and the length of most portions of pedal times a force exerted on pedal. Hence, the invention is labor-saving.

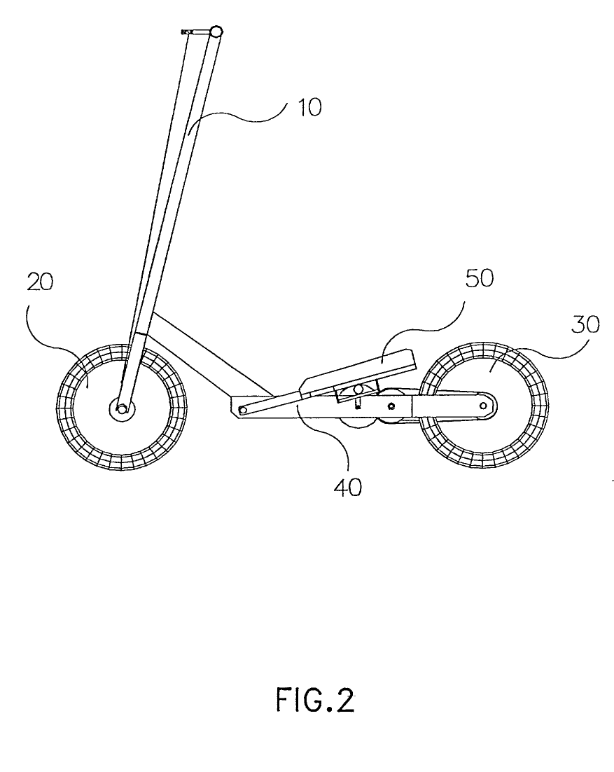

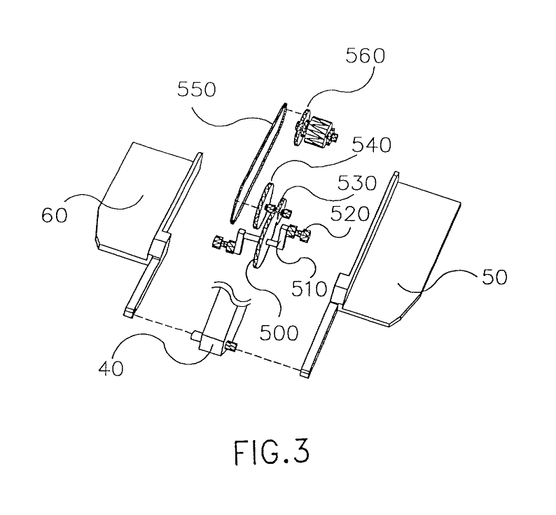

Referring to FIGS. 2 and 3, a first preferred embodiment of scooter-like bicycle according to the invention comprising a handle 10, a front wheel 20, a rear wheel 30, a main frame 40 and two pedals 50 wherein one end of pedal 50 is pivotably coupled to a front end of main frame 40 and a bottom portion of pedal 50 near the other end is coupled to bearing 520. Crank 510 is connected between bearing 520 and clockwise gear 500. Clockwise gear 500 is meshed with counterclockwise gear 530. Both counterclockwise gear 530 and front gear 540 are driven coaxially. A chain 550 interconnects front gear 540 and rear gear 560. In comparison with a conventional bicycle, the scooter-like bicycle of the invention is without saddle and frame is much simplified. This is one advantage of the invention.

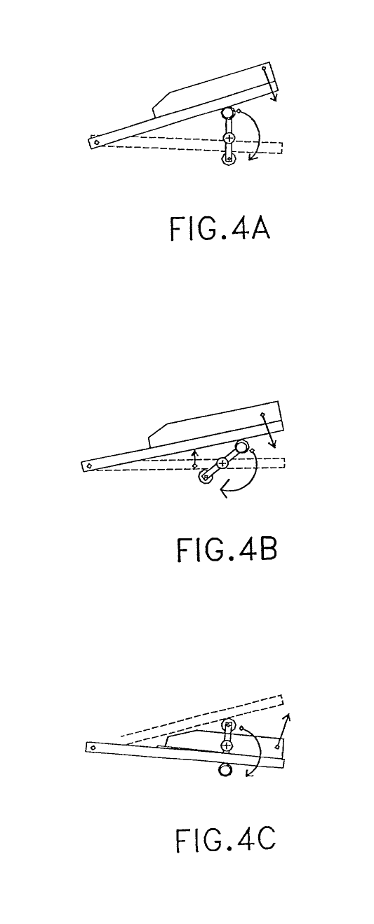

Referring to FIGS. 4A, 4B and 4C, operations of power transmission mechanism of the scooter-like bicycle are illustrated. In FIG. 4A, user pushes pedals to cause cranks to rotate clockwise through bearings. Hence, when one pedal is at a lowest position the other pedal is at a highest position (FIG. 4C). Front gear is rotated accordingly by such reciprocating motion of pedals. As a result, scooter-like bicycle moves forward. In operation, total weight of rider is exerted on pedals since rider is at a standing position. This can save the physical labor of legs. Further, the invention does not restrict the wearing of rider. This is another advantage of the invention.

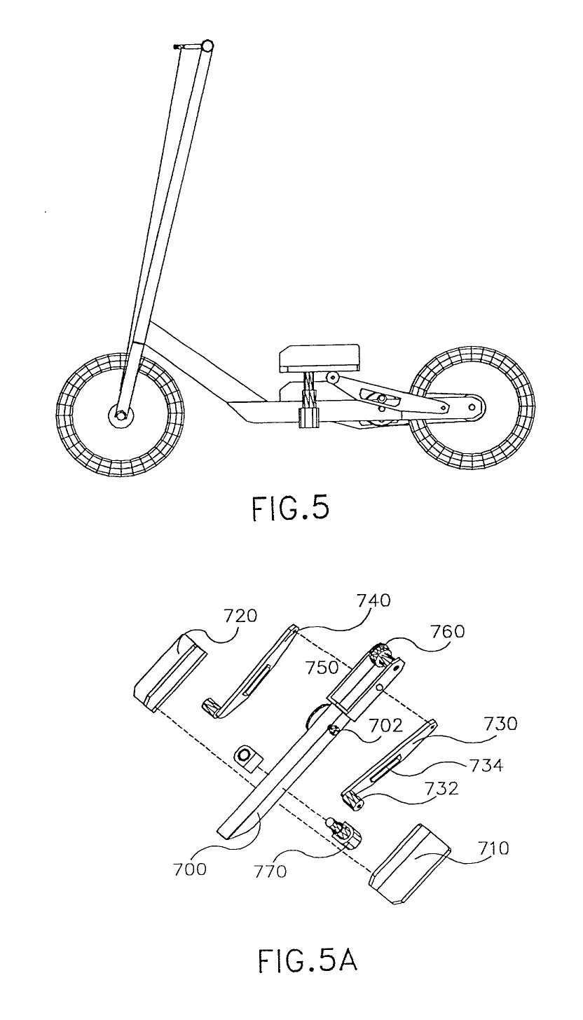

FIG. 5A and 5 illustrate a third preferred embodiment of scooter-like bicycle according to the invention. The features of this embodiment are that a bottom portion of pedal 710 near the front end is coupled to top of a plunger 770 which is secured to main frame 700, while another bottom portion of pedal 710 near the rear end is coupled to bearing 732 which is coupled to one end of crank 730. The other end of crank 730 is coupled to main frame 700. An elongate slot 740 is formed in crank 730. Another bearing 702 coupled to axle of clockwise gear 750 is confined in the slot 740 so that a pivot of crank 730 may cause clockwise gear 750 to rotate. As a result, rear gear 760 is rotated through a chain.

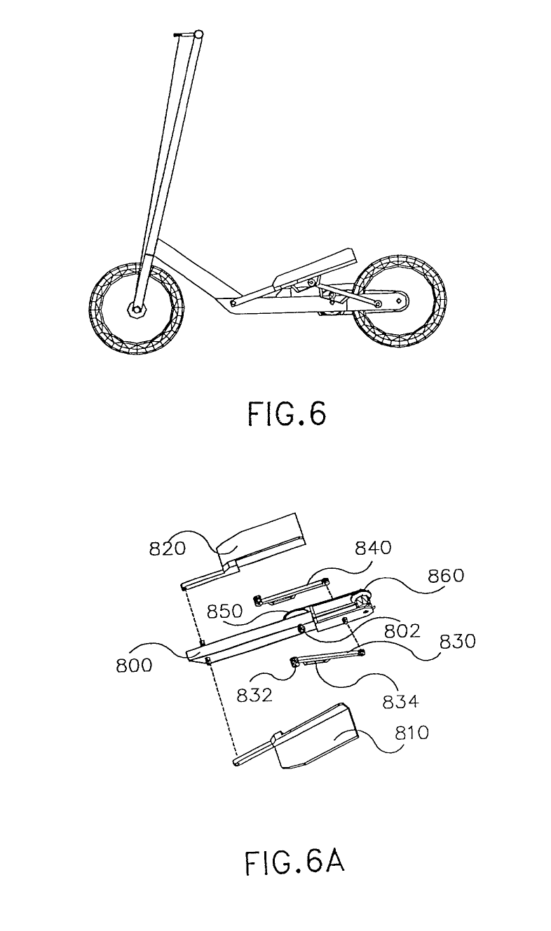

FIG. 6A and 6 illustrate a third preferred embodiment of scooter-like bicycle according to the invention. The features of this embodiment are that a front end of pedal 810 is coupled to main frame 800, while a bottom portion thereof near the rear end is coupled to bearing 832 which is coupled to one end of crank 830. The other end of crank 830 is coupled to main frame 800. A channel 834 is formed under crank 830. Another bearing 802 coupled to axle of clockwise gear 850 is confined in the channel 834 so that a pivot of crank 830 may cause clockwise gear 850 to rotate. As a result, rear gear 860 is rotated through a chain.

While the invention has been described by means of specific embodiments, numerous modifications and variations could be made thereto by those skilled in the art without departing from the scope and spirit of the invention set forth in the claims.

What is claimed is:

1. A scooter-like bicycle having a power transmission mechanism, said mechanism comprising:
a gear assembly including a clockwise gear, a rear gear coupled to a rear wheel, and a chain interconnected said clockwise and rear gears in a substantially horizontal level;
a crank having one end coupled to an axle of said clockwise gear and being disposed parallel to said clockwise gear; and
a pedal assembly including a first pedal and a second pedal at both sides of said clockwise gear, one end of each pedal being coupled to the other end of said crank and the other end thereof being coupled to a main frame.

2. The scooter-like bicycle of claim 1, further comprising a bearing interconnected said crank and each pedal.

3. The scooter-like bicycle of claim 2, wherein an axle of said bearing is coupled to said crank.

4. The scooter-like bicycle of claim 2, wherein a bottom portion of each pedal is coupled to top of said bearing.

5. The scooter-like bicycle of claim 1, wherein said pedal assembly is disposed parallel to said main frame.

6. The scooter-like bicycle of claim 1, wherein said pedal assembly is operated in a reciprocating motion.

7. The scooter-like bicycle of claim 1, wherein said pedal assembly is coupled to said main frame at a position either in front or rear of said clockwise gear.

8. A scooter-like bicycle having a power transmission mechanism, said mechanism comprising:
a bearing;
two pedals pushed downward to cause said bearing to rotate;
a crank being rotated as said bearing rotates;
a clockwise gear coaxial with said crank being rotated as said crank rotates;
a rear gear coupled to a rear wheel; and
a chain interconnected said clockwise and rear gears so that said scooter-like bicycle moves as said chain rotates.

9. The scooter-like bicycle of claim 8, wherein a bottom portion of each pedal is coupled to a periphery of said bearing in a first point so that said clockwise gear rotates clockwise when said first point is in front of said clockwise gear.

10. The scooter-like bicycle of claim 9, wherein said clockwise gear rotates counterclockwise when said first point is in rear of said clockwise gear.

11. A labor-saving mechanism mounted in a scooter-like bicycle, said mechanism comprising:
a gear assembly including a clockwise gear, a rear gear coupled to a rear wheel, and a chain interconnected said clockwise and rear gears in a substantially horizontal level;
a crank having one end coupled to an axle of said clockwise gear and being disposed parallel to said clockwise gear; and
a force-applying means at one side of said clockwise gear, one end of said force-applying means being coupled to the other end of said crank and the other end thereof being coupled to a main frame.

12. The labor-saving mechanism of claim 11, further comprising a bearing interconnected said crank and said force-applying means.

13. The labor-saving mechanism of claim 12, wherein an axle of said bearing is coupled to said crank.

14. The labor-saving mechanism of claim 12, wherein a bottom portion of each pedal is coupled to top of said bearing.

15. The labor-saving mechanism of claim 11, wherein said force-applying means is disposed parallel to said main frame.

16. The labor-saving mechanism of claim 11, wherein said force-applying means is operated in a reciprocating motion.

17. The labor-saving mechanism of claim 11, wherein said force-applying means is coupled to said main frame at a position either in front or rear of said clockwise gear.

18. A labor-saving mechanism mounted in a scooter-like bicycle, said mechanism comprising:
a bearing;
a force-applying means pushed downward to cause said bearing to rotate;
a crank being rotated as said bearing rotates;
a clockwise gear coaxial with said crank being rotated as said crank rotates; and
a rear gear being rotated as said clockwise gear rotates, thereby moving a main frame.

19. The labor-saving mechanism of claim 18, wherein a bottom portion of said force-applying means is coupled to a periphery of said bearing in a first point so that said clockwise gear rotates clockwise when said first point is in front of said clockwise gear.

20. The labor-saving mechanism of claim 19, wherein said clockwise gear rotates counterclockwise when said first point is in rear of said clockwise gear.
